(19) United States
(12) Patent Application Publication
(10) Pub. No.: US 2024/0393866 A1
(43) Pub. Date: Nov. 28, 2024

(54) RE-MAPPED OPERATOR ACTION AS RESPONSE TO PROMPT

(71) Applicant: Six15 Technologies, Henrietta, NY (US)

(72) Inventors: Theodore K. Ricks, Pittsford, NY (US); Paul S. Repka, W. Henrietta, NY (US); Alexander K. Sojda, Rochester, NY (US)

(73) Assignee: Six15 Technologies, Henrietta, NY (US)

(21) Appl. No.: 18/667,640

(22) Filed: May 17, 2024

Related U.S. Application Data
(60) Provisional application No. 63/468,306, filed on May 23, 2023.

(51) Int. Cl. G06F 3/01; G06Q 10/08; G06V 30/142; H04N 1/00

(52) U.S. Cl. CPC G06F 3/011; G06V 30/142; H04N 1/00384; H04N 1/00403; G06Q 10/08; G06V 2201/02

(57) ABSTRACT

A method displays information content received from a remote host system on a display controlled from a first processor that is separate from the remote host system and identifies, in the displayed content, at least one predetermined prompt field that prompts an operator response. A received event signal corresponds to the operator response from an input device that is in signal communication with the first processor. In response to the prompt field identification and to the received event signal, a pre-determined remapping re-interprets the event signal received from the operator at the first processor as a remapped signal that is the response to the predetermined prompt field. The remapped signal is transmitted from the first processor to the remote host system as the response to the predetermined prompt field and the remapping of the event signal is reset.

The present application claims the benefit of U.S. Provisional application Ser. No. 63/468,306, provisionally filed on May 23, 2023, entitled “RE-INTERPRETING OPERATOR ACTION AS RESPONSE TO PROMPT” in the name of Theodore K. Ricks et al., incorporated herein by reference in its entirety.

### FIELD OF THE INVENTION

The present application is directed to display of information content from an originating system on a wearable display or other personal display.

### BACKGROUND OF THE INVENTION

The advent of handheld and wearable electronic displays allows systematized instructional content to be displayed to a viewer in order to support task execution. In warehousing applications, for example, various types of displays can be provided to a worker whose function is to locate and procure a succession of items according to an order listing. To help support this particular type of dedicated task, any of a number of handheld or wearable display devices have been adapted, providing instructions such as a storage location, an item identifier, an item count, and the like. The use of portable display devices for warehouse worker assistance can help to streamline workflow and boost the overall speed and efficiency with which orders are serviced and shipped. From a broader aspect, it can be appreciated that for many functions requiring a sequence of tasks, such as in industry, medical care, or product delivery, providing instructions to specific personnel helps to eliminate confusion, improves tracking and workflow, and leads to improved efficiency.

Among display devices that have been adapted for this purpose are head-mounted displays (HMDs) and other types of heads-up display (HUD). An HMD configured for this purpose has a display controlled from a remote CPU allows a member of the warehousing staff, when wearing the HMD with the display suitably activated and in signal communication with the remote server, to work through each item in a picking list, efficiently locating and obtaining the item. In conventional workflow, the item can then be scanned for verification and inventory tracking and linked to a particular customer order, for example.

In order to display instructions on the HMD, a software application (or “app”) is required. At each warehouse site, a proprietary software application, typically stored and executed on HMD control circuitry, allows the computer system that originates an order to display suitable information content on the HMD.

The task of writing the proprietary software that provides the interface between the HMD and the originating computer system is non-trivial and can be costly. Each warehouse site, for example, can have a customized inventory control and ordering system that manages incoming and outgoing inventory, tracks order handling, stores location and identification data for individual items, etc. In many cases, the originating system for an ordered product can include software components written many years earlier, in outdated code formats that are unfamiliar to the current generation of software engineers. Moreover, management personnel are often wary of making changes or access calls to existing software logic, where the systems have been labored on over many years and operating personnel are familiar with how to use and maintain such systems, but reluctant to alter.

Yet another complication that can make it difficult to extract data from existing systems and software packages relates to the fact that different vendors can be involved with different areas of the software. In some cases, companies are reluctant to work with competitors or with third-party vendors who, in some cases, maintain rights to various related proprietary software, for example.

For some types of displayed instructions, user workflow requires some type of response from the user, such as a simple yes/no confirmation that a task was performed, or a response indicating or verifying a variable related to a workflow task, such as confirming a quantity or type of item obtained in a warehouse picking operation, for example. This added step can require a worker to manually enter response data, which can be very impractical or impossible when using an HMD, and can impede task performance for operators using other types of wearable or other personal displays. The combination of this difficulty with the reluctance of users to modify workflow practices can effectively prevent users from enjoying the advantages of hands-free HMD display.

It can thus be appreciated that significant complexity can hinder or even block the use of wearable displays in warehousing and other environments, even though the advantages of these devices are widely realized. Obstacles that can result from working with unfamiliar or even antiquated systems, negotiating with reluctant third-party companies, and providing a display interface that can be implemented, managed, and changed as needed, can seem insurmountable in some cases.

Thus, there is a need for solutions to the interface problems that face HUD developers and allow the advantages of HUD technology to be more readily accessed for existing applications.

### SUMMARY OF THE INVENTION

It is an object of the present disclosure to address the need for straightforward solutions to human interface generation and development for wearable displays and other types of HUDs.

With this object in mind, embodiments according to the present disclosure provide a method comprising:
displaying information content received from a remote host system on a display that is controlled from a first processor that is separate from the remote host system;
identifying, in the displayed information content, at least one predetermined prompt field that prompts an operator response to the remote host system;
receiving an event signal that corresponds to the operator response from an input device that is in signal communication with the first processor;
in response to the prompt field identification and to the received event signal, actuating a pre-determined remapping that re-interprets the event signal received from the operator at the first processor as a remapped signal that is the response to the predetermined prompt field;
transmitting the remapped signal from the first processor to the remote host system as the response to the predetermined prompt field;
and
re-setting the remapping of the event signal.

According to an alternate embodiment of the present disclosure, there is provided a method comprising:
displaying, information content received from a remote host system on a display that is controlled from a first processor that is separate from the remote host system;
identifying, in the displayed information content, at least one predetermined prompt field that prompts an operator response;
receiving a first event signal that corresponds to the operator response from an input device that is external to, and in signal communication with, the first processor and transmitting the first event signal from the first processor to the remote host system;
in response to the prompt field identification and to the received first event signal, actuating a pre-determined remapping that re-interprets a second event signal received from the operator at the first processor as a remapped signal that is a response to the predetermined prompt field;
transmitting the remapped signal from the first processor to the remote host system as the response to the predetermined prompt field;
and
re-setting the remapping of the event signal.

### BRIEF DESCRIPTION OF DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1A is a schematic diagram that shows conventional use of a handheld display to show task-oriented instructional information for a viewer.

FIG. 1B is a schematic diagram that shows how an exemplary HMD device can complement or replace the use of handheld display devices for providing task-oriented instructional information to the viewer.

FIG. 2 is a schematic diagram that compares structures and operation of the Applicant solution to the conventional approaches shown in FIGS. 1A and 1B.

FIG. 3 is a logic flow diagram that shows a sequence for generating HUD image content on a second display using screen capture content from a first display according to an embodiment of the present disclosure.

FIG. 4A shows an exemplary user interface for configuration of key word and command word fields.

FIG. 4B shows an example of display on a wearable display for the configuration provided in FIG. 4A.

FIG. 5 shows an exemplary user interface for error and warning word configuration.

FIG. 6 shows an exemplary user interface for specifying text strings to ignore from the source display.

FIG. 7 shows an exemplary user interface for specifying text attributes from the captured screen image.

FIG. 8 shows an exemplary prompt/response sequence forming part of user interaction.

FIG. 9 shows another exemplary prompt/response sequence forming part of user interaction.

FIG. 10A is a schematic diagram showing operator interaction according to a conventional model.

FIG. 10B is a schematic diagram showing operator interaction according to an embodiment of the present disclosure.

FIG. 11 is a logic flow diagram that shows a sequence executed by the Applicant's app for handling operator response.

FIG. 12 is a sequence chart that shows one exemplary sequence for changes in the context of operator action according to an embodiment of the present disclosure.

FIG. 13 shows an example user interface for setup of programmed responses.

### DETAILED DESCRIPTION OF THE INVENTION

Figures provided herein are given in order to illustrate principles of operation and component relationships according to the present invention and may not be drawn with intent to show actual size or scale. Some exaggeration may be necessary in order to emphasize basic structural relationships or principles of operation. Some conventional components that would be needed for implementation of the described embodiments, such as support components used for providing power, for packaging, and for mounting, for example, may not be shown in the drawings in order to simplify description of the invention. In the drawings and text that follow, like components are designated with like reference numerals, and similar descriptions concerning components and arrangement or interaction of components already described may be omitted.

Where they are used, the terms “first”, “second”, and so on, do not necessarily denote any ordinal or priority relation, but may be used for more clearly distinguishing one element or time interval from another. The term “plurality” means at least two. The term “exemplary” relates to example embodiments and applications that illustrate typical setup and use for the sake of description, without connoting preference or limitation.

In the context of the present disclosure, the term “energizable” describes a component or device that is enabled to perform a function upon receiving power and, optionally, upon also receiving an enabling signal.

The term “actuable” has its conventional meaning, relating to a device or component that is capable of effecting an action in response to a stimulus, such as in response to an electrical signal, for example.

In the context of the present disclosure, positional terms such as “top” and “bottom”, “upward” and “downward”, and similar expressions are used descriptively, to differentiate different surfaces or views of a device and do not describe any necessary orientation of the device. In the context of the present disclosure, the term “hand-held device” relates to portable electronic devices equipped with a display and configured to be viewed and operated while held in the hand, including cell phones, devices such as the iPad (Apple Computer) or Android tablet, and similar devices, for example.

In the context of the present disclosure, the term “coupled” is intended to indicate a mechanical association, connection, relation, or linking, between two or more components, such that the disposition of one component affects the spatial disposition of a component to which it is coupled. For mechanical coupling, two components need not be in direct contact, but can be linked through one or more intermediary components.

In the context of the present disclosure, the term “image” is used to refer to a “pixelated” image, a pattern comprising the array of pixel data that is recorded from a display screen. The image described herein is a type of pixel pattern or “bitmap”, not limited to any specific data format. The related term “image capture”, as used in the software development art, relates to recording, at a point in time, a copy of the pixel array data for a display. The terms “image capture” and “screen capture” are considered equivalent for the purposes of the present disclosure.

The term “in signal communication” as used in the application means that two or more devices and/or components are capable of communicating with each other in at least one direction via signals that travel over some type of signal path. Signal communication can be wireless. The term “event” is used herein to indicate an action that causes a signal to be generated, such as an operator press of a scanner button, for example.

In the context of the present disclosure, the term “display” may be used as equivalent to “display device”, “personal display”, “handheld display”, “heads-up display”, and other variants of these terms, and can include cell phones, various types of display device configured for mounting on the arm or wrist, on clothing, on a cart or other support vehicle, HMDs, or other HUDs. Although not explicitly shown herein, each display device has a supporting processor of some type, rendering received image data on the corresponding display surface and managing signal communication with one or more other processors for exchange of information related to the display function.

In the context of the present disclosure, the general term “personal portable display device” or, more simply, “personal communications device” or “portable display device” or “handheld display device” is broadly and equivalently used to encompass any of a number of types of wireless mobile or portable personal communications devices that are carried by a user and include display that shows content that can be internally stored or provided from a separate host system. Display devices of this type can include cellular phones, so-called “smartphones” that provide some type of mobile operating system with image capture and display, feature phones having at least some measure of computing and display capability, and various types of wireless, networked electronic pads, tablets, and similar devices that have a display area and can typically include a camera. The display area is capable of displaying text and graphic content and, optionally, can include a mechanism for entering data, such as manually entered, textual prompt responses, on the display screen, for example. The mechanism for data entry typically includes a touch screen and may also include a keypad. Examples of types of personal communications devices that can work with HMD and other display types and can work with embodiments of the present disclosure include smartphones such as the Android™ smartphone platform (Android is a trademark of Google, Inc.), the iPhone (from Apple Inc.), and devices with similar capability for image acquisition and display, optionally including the capability for downloading and executing one or more sets of programmed instructions, such as software applications that are widely referred to as “apps” that display on the device. The personal communications device has a particular wireless address, typically a phone number, but optionally some other type of wireless address.

The term “handheld”, as used in the context of the present disclosure, is used in a generic sense, descriptive of device size and typical use. A handheld device is not limited to use only when couched in the hand of a user. Thus, for example, a laptop computer or computer tablet can be considered as handheld devices in the context of the present disclosure, even though they can often be used on a tabletop or floor or cradled on the user's lap.

The term “set”, as used herein, refers to a non-empty set, as the concept of a collection of elements or members of a set is widely understood in elementary mathematics. The term “subset”, unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

In the context of the present disclosure, the term “app” is considered to be synonymous with the phrase “software application” or “software application program” and relates to a set of one or more programmed instructions that execute on a computer or other logic processor, such as the logic processor that controls operation of a smartphone or other person communications device.

Embodiments described herein show examples that are typical of warehousing applications, which is one of a number of business sectors and activities for which methods and apparatus of the present disclosure can be of particular value. It should be emphasized that warehousing and supply illustrations are given by way of example, not limitation. A common trait for such applications relates to transmitting instructions in order to inform task execution.

Verifying task execution, such as completion of an order fulfillment assignment, and other tracking can be performed using any of a number of mechanisms, such as using a hand-held scanner or “ring scanner” or similar automated device, as well as other types of operator input devices, including a touch or tap on the display of a handheld device; signals generated from operating a position sensor, such as an inertial measurement unit (IMU) or a global positioning system (GPS) device; a button press on an input button provided on an operator display or headset; or, where a microphone or other audio input device may be available, an audible command, for example. Embodiments of the present disclosure are directed to facilitating user response to a prompt that is related to task execution, without requiring explicit manual entry or typing of the user response on the personal display device.

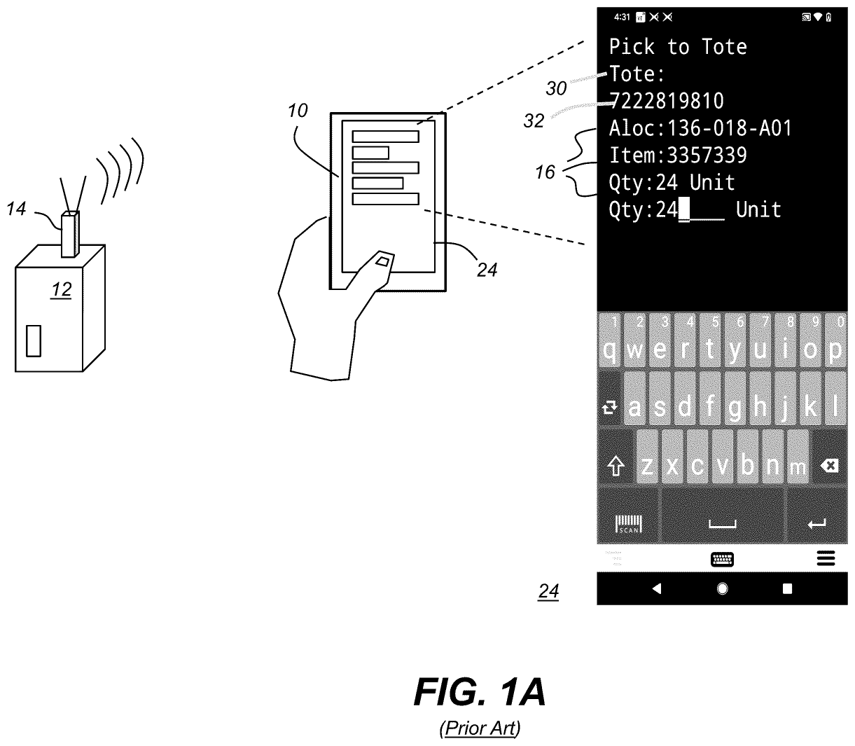

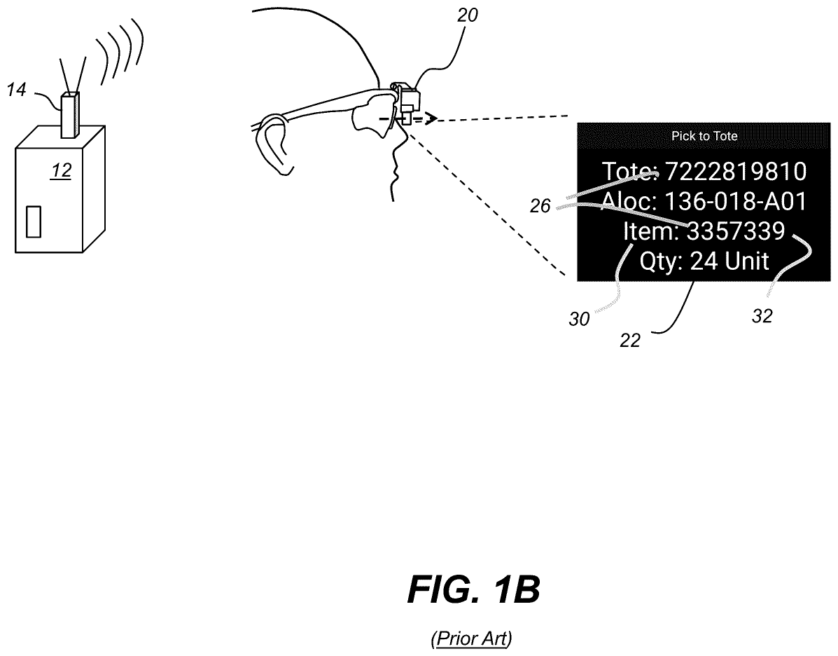

FIG. 1A is a schematic diagram that shows conventional use of a handheld display device 10, also referred to herein as display 10, used to provide alphanumeric information, such as task-oriented instructional information, for a viewer on its display as image 24. The example of FIG. 1A shows a set of labels 30 and their corresponding variables 32. In this conventional approach, a central server 12, typically a computer or other type of logic processor that serves as a host system, communicates through WiFi, or other wireless transmission mechanism, to workers who are awaiting tasks or assignments. Each worker can have a cell phone, smart phone, pad, or other handheld display device 10 that is configured to receive server 12 transmissions from the host processor, sent from a WiFi router 14 or other transceiver as represented in FIG. 1A.

In order to convey the task or order information with informational data fields 16 from server 12, some type of logic interface is required between server 12 and the networked display device 10. This interface can be, for example an applications interface or API (Application Programming Interface) that is designed and standardized for a system, or a custom interface designed specifically to communicate instructions for task execution. An app (software application) executing on handheld display device 10 interacts with server 12 to acquire and display text contents. In the example of FIG. 1A, text content that is acquired and displayed in image 24 is in the form of simple text instructions, with one or more fields 16, typically with one labeled field per line entry as shown.

A notable disadvantage of the conventional instructional display paradigm of FIG. 1A relates to the requirement that the user hold the display device 10 in hand while performing the task of locating and obtaining an item. Accidents happen, and if the display device 10 is dropped onto a concrete floor, it can be damaged. In addition, the viewer must continually look down to see the displayed image 24 on the hand-held device, which requires repetitive movement and may raise safety concerns.

Wearable display devices can alleviate some of the problems described for handheld display devices 10. FIG. 1B is a schematic diagram that shows how an exemplary HMD device 20 or other HUD can complement or replace the use of a handheld display device 10 for providing task-oriented instructional information to the viewer. The HMD, and HUD devices in general, are hands-free, displaying information that is useful to the viewer, but allowing the viewer to walk about more safely, for example, or even to drive a cart or vehicle while the display 22 is within the viewer field of view.

In the context of the present disclosure, the term “heads-up display” or HUD presents content that supplements the normal visual field of the viewer, rather than requiring that the viewer re-direct attention away from the visual field that lies ahead in order to view the display contents. The HUD can be considered to include any of a range of suitable head-mounted displays (HMD) including glasses, goggles, or display attachments to eyewear, as well as to other display devices that are worn, cart- or vehicle-mounted, or otherwise configured to remain within the visual field of a viewer and to allow hands-free operation simultaneous with the display of content within the viewer's visual field. Illustrative examples are given herein to HMDs; however, the functions and behavior described for HMDs can generally be extended to other types of HUD devices.

As can be seen in the simple display 22 example of FIG. 1B, informational fields 26 on the HMD device 20 are necessarily space-constrained and because of this limitation can have a reduced number of terms or may use appropriate abbreviations to take up less space. However, in many cases, as suggested in the example of FIGS. 1A and 1B, only a few text fields may be needed in order to provide the essential information for performing a task such as item selection or site-specific function for example.

The overall arrangement of FIG. 1B can use the same communication mechanism for receiving display information from server 12 that was described with reference to FIG. 1A. An app executing on the HMD device may execute in order to obtain data fields from server 12 through an API or custom interface.

As was noted in the background description, the conventional approach for communication between the server 12 at the site and the display device, whether handheld device 10 as in FIG. 1A or HMD 20 as in FIG. 1B, has typically required some amount of custom integration with computer servers and related hardware at each system or site location. Because there are many potential system combinations and numerous variations, often with customization site-to-site, including customization by different, unrelated software vendors, it can be appreciated that some universal, standardized method for adapting existing data display content to formats readily usable by an HUD system would be advantageous. However, no such standardized facility exists for straightforward conversion to HUD display for “legacy” systems.

The Applicant solution addresses the interface problem by considering how to adapt existing software and tools to the interface task without jeopardizing data integrity and without extensive rework for integration with legacy systems and software. Embodiments of the present disclosure take advantage of existing systems that are already designed and that already operate for generating instructive text content on a primary display. The Applicant's solution provides methods for accessing the needed text content from the primary display in its displayed image form, extracting the needed text content from an “image capture” of the hand-held display 10, then using this extracted content for display as an HUD image, without requiring an extensive software/hardware development effort.

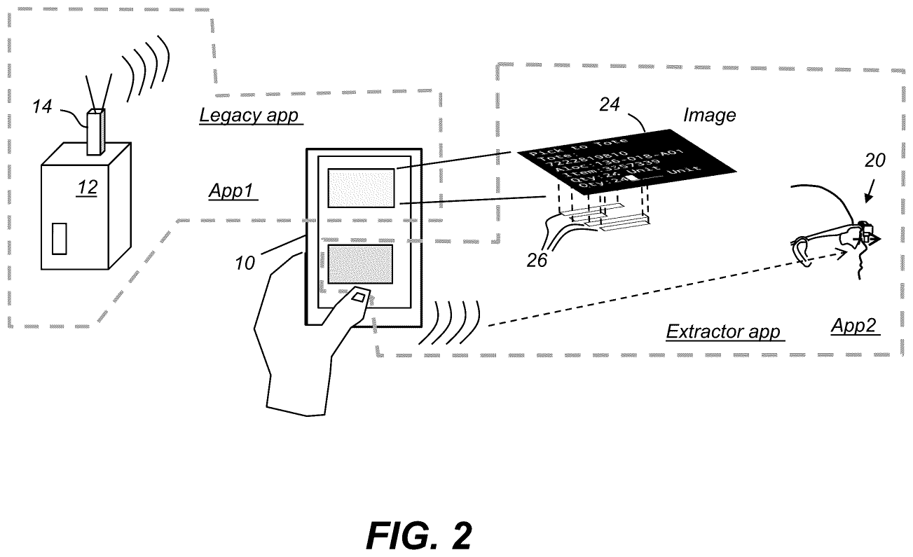

The schematic diagram of FIG. 2 compares structures and operation of the Applicant solution to the conventional approaches shown in FIGS. 1A and 1B. For the existing “legacy” application labeled App1, the hand-held display 10 continues to operate as shown in FIG. 1A. That is, server 12 communicates with the hand-held primary display 10, generating image 24 that provides the source for label and variable text content needed for display to the viewer for task execution or other purpose.

The Applicant solution adds another application to handheld display device 10, labeled in FIG. 2 as an “extractor” application App2. The extractor App2 operates independently of App1. The extractor app App2 can continuously search image 24 (the output of App1) on display device 10 to extract data fields 26 for display on a secondary display, here HMD 20. However, instead of processing the data content itself that is used by App1 to generate the displayed text fields, the Applicant's App2 uses only the displayed, pixelated image 24 of display device 10 as its source for obtaining the text strings of interest from the primary display image. App2 then generates and renders the needed data fields 26 onto the secondary HMD display, typically as alphanumeric text strings, providing at least the variable data content and, where possible, the corresponding label(s).

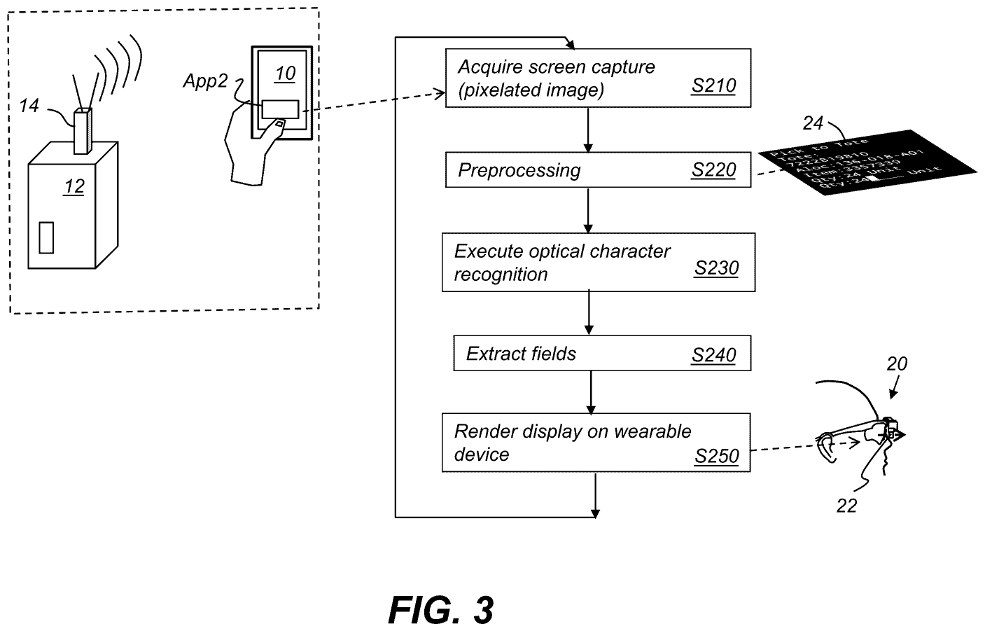

FIG. 3 is a logic flow diagram that shows how App2 operates. A display image acquisition step S210 executes by acquiring a screen capture from handheld display device 10. Most types of display devices 10, such as cell phones, provide a native screen capture utility that can be invoked from a software application running on the device. For example, both iPhone™ devices and Android™ devices provide a capture command that generates a pixelated, or bit-mapped, image of the device display. Step 210 uses the system command for screen capture and acquires the corresponding pixelated image 24 from display 10. A preprocessing step S220 can pre-process the acquired pixel content to distinguish the area of image 24 having content of interest from other parts of the captured screen. Step S220 can include, for example, eliminating border content, cropping out standard icons that typically display to show status of the cell phone, time, battery charge, and the like, as well as distinguishing display text from unwanted keypad text characters and various icons for unrelated functions. Text intended for further processing can be identified according to pre-programmed characteristics, as described in more detail subsequently.

An optical character recognition (OCR) step S230 executes on the acquired, pixelated display image 24. OCR step S230 can identify alphanumeric text strings that are presented within pixelated image 24 that has been captured. OCR processing is well-known and can be implemented using custom software or any of a number of OCR software products.

In a fields extraction step S240, App2 searches the identified text strings in the image 24 content for programmed keywords or text “markers” that indicate the text of interest that provide HMD display “labels”. This text of interest that is adjacent to or follows the labeling keywords typically includes the related variable text fields to which each respective label applies, needed for HMD display.

A display rendering step S250 then generates an HUD display 22 (FIG. 1B) that shows selected fields to support the given application. The control logic execution shown in FIGS. 2 and 3 can repeat periodically, such as whenever the display 10 is updated, following a confirmation signal provided from the end-user indicating task completion, or as a continuous loop, such as one or more times per second, for example.

In a warehousing application, for example, server 12 assigns tasks for order fulfillment from the warehouse inventory. Specific tasks need to include various information fields that would be common to any order fulfillment scheme. For example, a worker fulfilling a customer order would follow some type of listing that identifies fields such as the following:
(i) Order identifier
(ii) Item number or part number
(iii) Quantity
(iv) Part location (such as aisle number, shelf number, bin designation, and the like).

In the example shown with reference to FIG. 3, the display is generated on an HMD. However, it should be noted that the target device need not be a wearable display, but may be some other type of display.

### Configuration Setup for App2 Execution

From the computer system, server 12 at any particular site, the needed information given in image 24 can be given in any order, and may appear on various parts of a printed or display surface. According to an embodiment of the present disclosure, the extractor application App2 can be configured to select, perform OCR, and display the desired text strings extracted from the screen display 10, based on fixed dimensional coordinates for the display 10 surface. This approach avoids the need to interface directly with host server 12 software. However, applying this strategy would require precise knowledge of the dimensional arrangement for display 10 information, which can vary with the specific type or model of personal handheld device. Moreover, modifications or revisions to the image 24 display format or to the display device 10 itself would require re-configuration of the app2 function. The type of reconfiguration needed would be inconvenient, requiring customization at each site, and may be prohibitive for personnel lacking formal computer software skills.

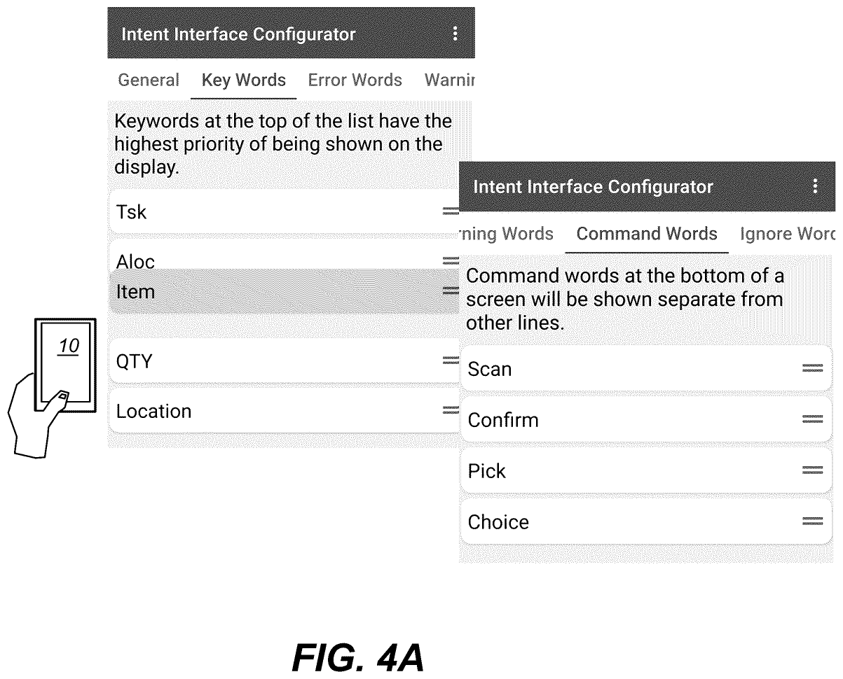

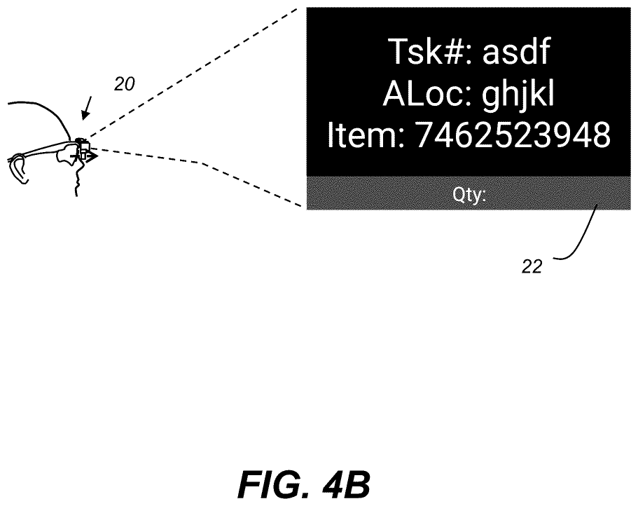

The Applicant solution is to provide the end-user with a configurable interface that identifies text of interest from display 10 using a set of keywords. Exemplary configuration screens for this user interface are shown in FIGS. 4A, 5, 6, and 7. By way of example, a basic logic sequence can proceed as follows:

(i) The OCR utility detects alphanumeric text strings in the display 10 content.

(ii) Each detected string is checked against a previously configured listing of keywords. The keywords can identify instructions, or may act as labels for specific information, for example, such as information relevant to a warehouse order fulfillment task. This could include keywords associated with task instructions, part number, order number, quantity, location, for example. An exemplary set of configuration screens for entering and ordering keyword information that can serve as data labels is shown in FIG. 4A.

(iii) The variable data string associated with each specified keyword is identified. The keywords and the corresponding data fields to which the keywords apply can then be rendered on display 22 of the HMD 20, as shown in the example of FIG. 4B. Labels, equivalent to the keywords, and the variable alphanumeric content associated with the keywords, can be displayed. Where space is not available, only the variable text content may display, without labeling text, or with labels abbreviated.

(iv) Command terms (FIG. 4A) and other configured fields can optionally be identified and displayed. It should be noted that fields of interest can also be identified by characteristics such as position on the display screen or by display attributes such as font, color, or other text/command treatment.

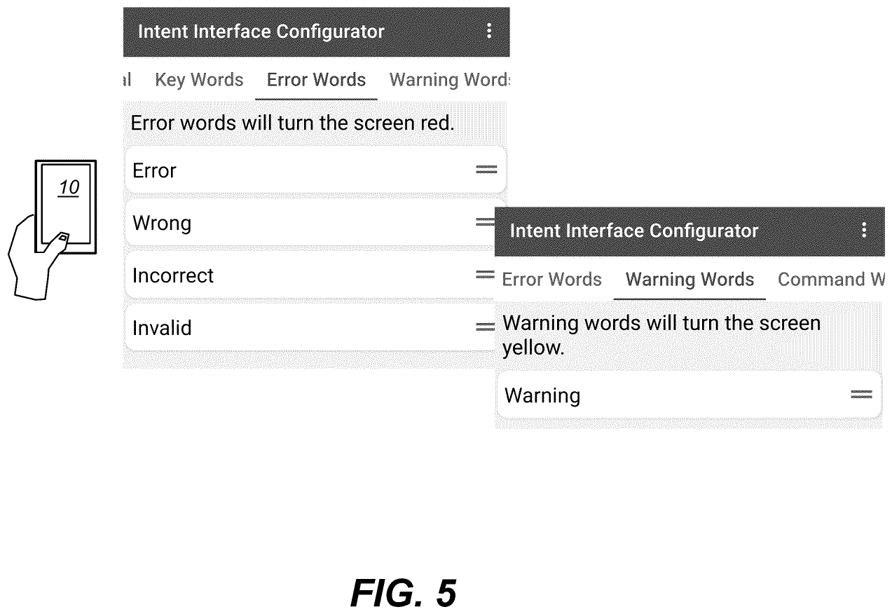

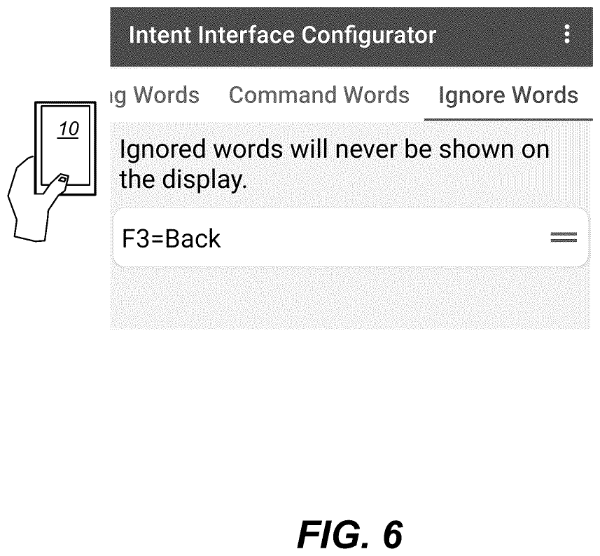

As shown in the examples of FIG. 5, the user can also enter terms related to warnings, alarms, or errors, including screen response where these terms are detected. As shown in FIG. 6, the user can configure the App2 interface to ignore specified fields in image 24 so that they do not appear on the HUD display 22.

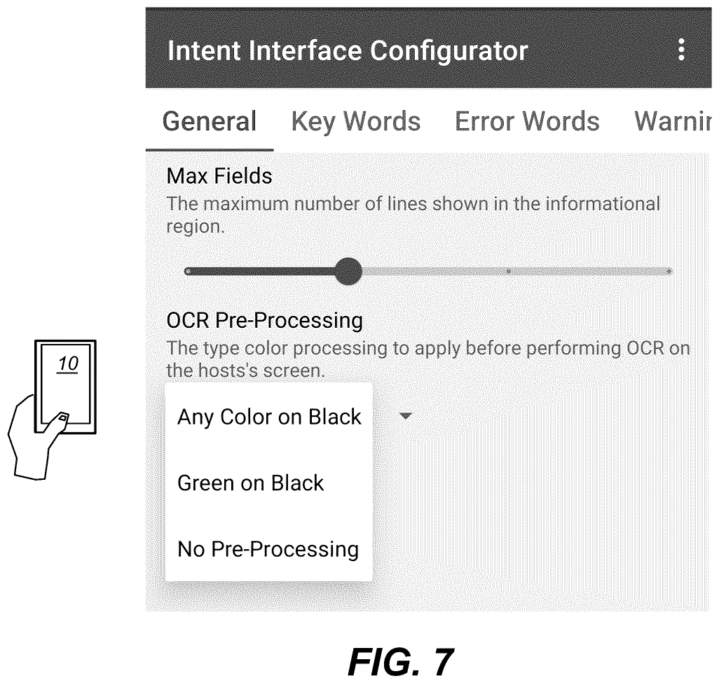

It should be noted that App2 can continuously execute the sequence of FIG. 3 on the displayed image 24 of display device 10. To avoid confusion where applications other than App1 may control display 10 and may display text data not intended for OCR processing, the App2 configuration utility can allow the user to specify font color and other characteristics of the text of interest within image 24, as shown in FIG. 7. Thus, for example, personal text messages, camera images, or web page content can be excluded from the OCR processing and display sequence described with reference to FIG. 3.

Because the overall number of fields with information necessary for a particular type of task can be limited and can be readily listed by a client, the extractor App2 can be configured by an end-user, rather than requiring the skills of a software developer. As shown in FIG. 1B, for example, only a small number of information fields can be displayed on display 22, particularly in an application where the viewer needs to be able to see past the HMD display.

As was described with reference to FIG. 2, the method of the present disclosure does not “communicate” by exchanging data with other software programs. The data that is used to determine the values or identifiers that are displayed on the HUD is taken from a screen capture of image 24. The screen capture is acquired from an intermediate display, in this case, from a handheld display 10 such as a cell phone. Optionally, the screen capture could be obtained from a personal computer, pad, smart watch, or other device that is configured with the necessary software logic for communication of commands and instructions from server 12, which may be, for example, a mainframe computer configured to display image 24. According to an embodiment of the present disclosure, the screen can be de-energized during the screen capture.

The format of image 24 data can be any format suitable for OCR processing by the App2 application. The pixel image provided from screen capture can be in a proprietary format of the manufacturer of the cellphone or other handheld device. In some cases, the screen capture can be saved as a .jpeg or .png image, for example. Because the extractor App2 uses the display image 24, it can be appreciated that instructions and text of interest can also be obtained from images of printed copies or from captured images of other screens or documents.

Referring back to the functional arrangement shown in FIGS. 2 and 3 and described hereinabove, it is possible for the display of handheld device 10 to be turned off or in a “sleep” or non-displaying power-saver mode while the HMD/HUD display continues to operate.

### Implicit Confirmation Sequence and Use of a Surrogate “Trigger”

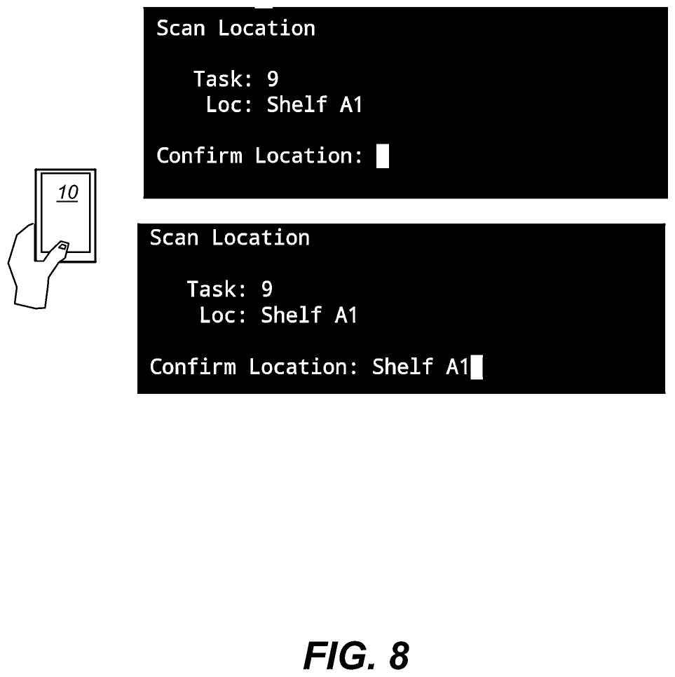

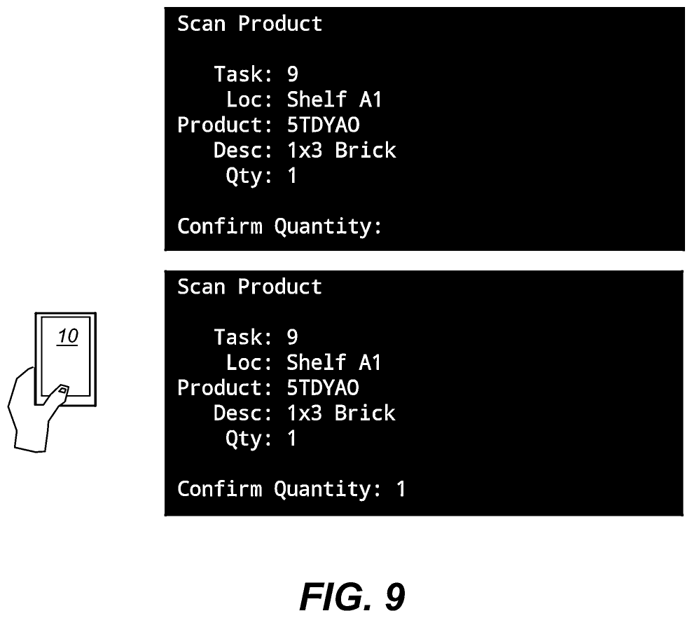

In warehousing and related applications, the user of handheld display 10 or, alternately, of HMD device 20 or other wearable display device, may also be required to respond to a prompt from the originating application. Continuing with the example of FIGS. 1A and 1B, FIGS. 8 and 9 show exemplary prompt/response sequences that are part of the user interaction. In the FIG. 8. example, the operator is prompted to confirm operator arrival at a particular location (Shelf A1). In the FIG. 9 example, the operator is prompted to enter and confirm a quantity (1) of a particular product (product 5TDYA0) at that location.

Some handheld devices provide a keypad or other mechanism that allows operator entry and confirmation of a textual response, which can be typed in by the operator. When the operator has both hands free, data entry and prompt confirmation on a cellphone or template device is straightforward. However, in practice, such as in a warehousing application, the operator's hands are often already occupied. The operator may not be able to use both hands to enter data or to otherwise respond to a prompt without the extra steps of pocketing or otherwise setting down a hand-held scanner, laying down a picking basket, stopping a cart or other unit of moving equipment, or otherwise temporarily interrupting the execution of the required task.

Moreover, where an HMD or other HUD is used to provide information and display a prompt request, no separate keypad is generally available. For operator response indicating completion of a data entry/confirmation task using conventional approaches, it would be necessary that the operator be provided with an additional device, such as a separate keyboard or other manual data entry device that is configured to cooperate with the inherently hands-free HMD/HUD apparatus.

Thus, it can be appreciated that conventional solutions to the problems of prompt response can have unsatisfactory aspects, including added cost and complexity, disturbance to existing workflow practices, additional steps for task execution, and lost time and productivity. To address the prompt response problem, the Applicant solution provides a method for generating a response confirmation signal using a triggering event initiated by the operator and re-interpreted by the Applicant system for reporting a prompt response to the system host. The triggering event itself can be “indirect”, with the operator response using a device or mechanism that has been logically “remapped” to indicate an input event that is not intrinsically related to the specific prompt request. By this remapping, the Applicant system re-interprets a detected operator action as a “substitute” or surrogate trigger event for data entry or confirmation. For example, the re-interpreted input event can be remapped to substitute a textual response to a command or instruction that originates at the host. Using this sequence, for example, the same hand-held scanner can have a dual function, used first as a scanner to acquire and report an encoded pattern, then, a moment later, used to provide an event signal that sends a text character or other signal indicating successful completion of an action. Notably, the scanner device itself is not “re-programmed” to provide an alternate type of signal; Signals received from the scanner can remain the same, whether the scanner is used for reading an encoding or for entering a re-mapped response. Actuation of the scanner returns the scanned data signal (or indicates that an encoding is unreadable) both when used as a scanner for reading an encoding and when used as a remapped input device.

The Applicant solution provides an app that is intermediary between the host server 12 application, a user data entry input device such as a scanner, and, whether or not an HMD 20 or other HUD is used, the displayed content. This configurable, remapping setup allows the intermediary app, controlled by a first processor that is separate from the host system, to reinterpret an operator action (e.g. scanner actuation), as a predefined trigger event, in order to provide a response that is awaited by the remote host server. The operator action can include any suitable and detectable operator action, including pressing a mechanical trigger, but also including other acts of the operator, as described in examples given subsequently. The sequence described herein can be part of app2, as described with reference to FIG. 2, for example.

As one example, the display on device 10 (or on the HMD/HUD) may prompt the user to enter and confirm a quantity (QTY), as was shown in the example of FIG. 9. The Applicant solution allows a pre-programming setup to designate the triggering event that has been remapped to serve as a surrogate response, such as pressing the scanner control button an additional time to confirm the displayed quantity. Upon receiving the triggering event (here, the additional transmission signal of scanner-encoded data, regardless of the data content itself), the Applicant's intermediary software app, running on a first processor that is separate from the hose system, interrupts the actual scanned data and, in response to the trigger event, substitutes or replaces the data content from the scanner with the desired quantity and confirmation data needed by the host application. The host server 12 then receives, from the intermediary app, the response it needs in order to ensure proper completion of the task and can proceed to assign the next task. The desired quantity, for example, can simply list the intended value given as a default, thus simply requiring operator confirmation, which is typically binary (yes/no or confirm/fail).

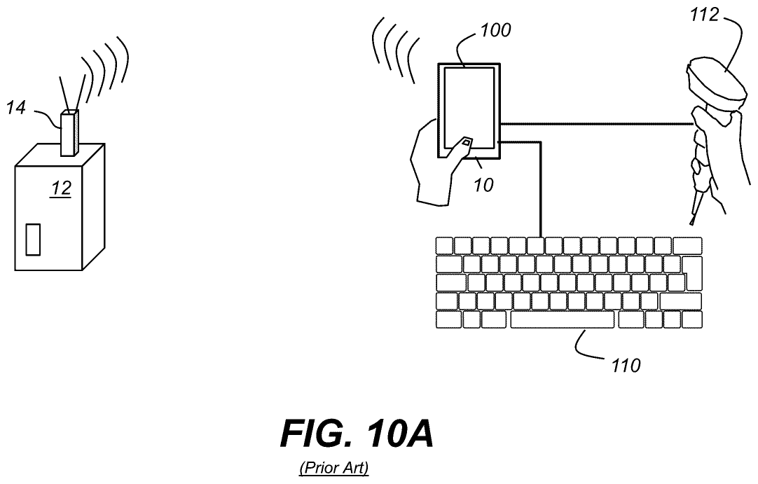

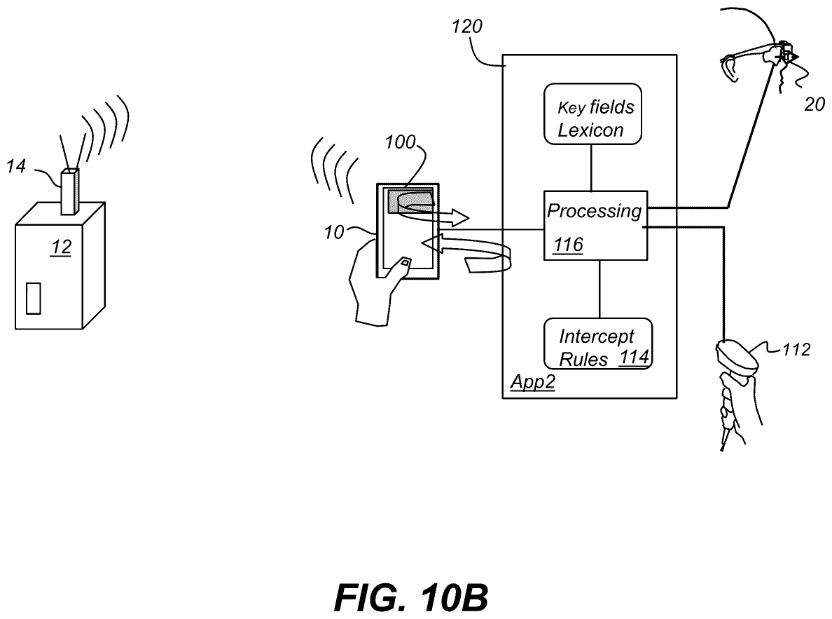

It is instructive to contrast the conventional prompt/response mechanism for communication between the host server 12 and the operator shown in FIG. 10A with the Applicant solution for communication with the host server 12 shown in FIG. 10B. In the conventional model of FIG. 10A, the host server 12, for task execution, communicates with a terminal emulator 100 that executes on handheld display device 10. Handheld device 10 may include or be in signal communication with a keyboard 110 or other operator entry device for text entry and confirmation. Alternately, a separate keyboard 110 or other entry device can be added to supplement display device 10. A scanner 112 can be in communication with display device 10 for reading bar codes or other encodings related to task execution. Message text and instructions for the operator are displayed on handheld display device 10. There is no remapping with the conventional FIG. 10A configuration, as described herein; the terminal emulator is typically controlled from the host server 12. The burden for controlling and interpreting operator interaction is on the host server 12 software.

In contrast, the Applicant solution in FIG. 10B requires no change in the operation of host server 12 or its programmed software for task execution. Similarly, no change is required in the behavior of terminal emulator 100, executing on display device 10, relative to host server 12 or to the operator. There is no change in the communication protocol or transaction aspects of the communication signals transmitted between host server 12 and display device 10. The Applicant's intermediary app2 120, as described previously, can optionally allow the use of HMD device 20 or other HUD, by extracting identified fields from the displayed text on display device 10. In addition to the “extractor app” field extraction and display functions described with reference to FIG. 2, app2 120 can also control interaction with scanner 112 and interaction with any other operator input device. A logic processor 116 portion of app 120, using intercept rules 114 programmed by the user and described in more detail subsequently, controls how the scanner input data is interpreted before it is communicated to terminal emulator 100 and hence communicated to host server 12, depending on the context. For example, when the scanner 112 information simply identifies a product encoding, the encoded bar code data from the scanner 112 can be transmitted directly to host server 12. Alternatively, when scanner 112 content can be re-interpreted by a re-mapping, actuated as described herein, using user-entered intercept rules 114, to be a type of trigger response or operator confirmation, app2 120 substitutes the required response or confirmation to the terminal emulator 100, rather than providing the scanner 112 reading (i.e. the encoded data), for transmission to host server 12. In an embodiment of the present disclosure, for example, the default quantity that displays from app2 can be the same quantity that is listed in the task that is communicated to the operator by the host system, so that confirmation by the operator simply indicates success, that is, that the expected quantity that displays in the work instruction has been provided by the operator. In the example of FIG. 10B, the operator can confirm obtaining this quantity by squeezing the scanner trigger at the appropriate time. The scanner need not point to any particular object or obtain a “valid” scan of an encoded label when used to respond to a confirmation prompt, such as a yes/no prompt to indicate completion, for example.

According to an alternate embodiment of the present disclosure, a voice command from the operator can be programmed as a surrogate response trigger entry to a user prompt. For whatever operator action is used, the context of a prompt displayed on display device 10 determines how the operator input (such as pressing the scanner trigger) is interpreted.

Designed to operate in the manner just described, app2 120 preserves the original software processes of host server 12 unchanged, as well as retaining the original “terminal emulator” software processes of display device 10. App2 120 performs the service that allows the triggering of surrogate operator responses, according to stored intercept rules 114, and the intended re-interpretation of the surrogate responses, without adding manual text entry, keyboards, and other conventional apparatus to the warehousing or other application.

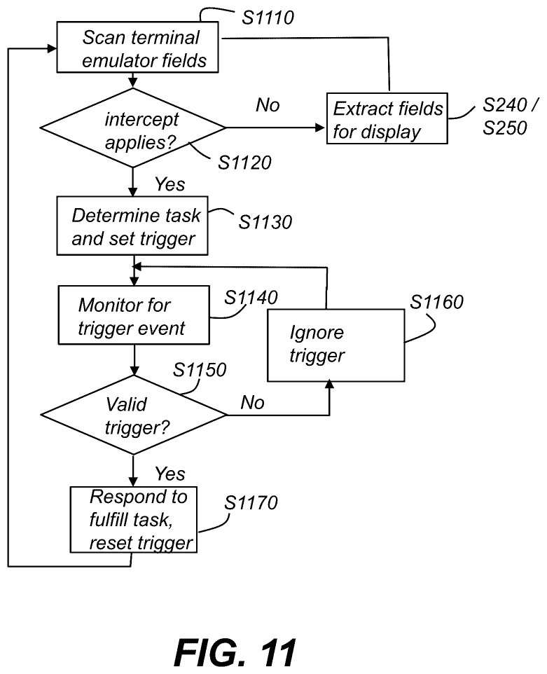

The logic flow diagram of FIG. 11 shows a sequence that can be executed by processor 116 of the Applicant's intermediary app2 for handling operator response according to an embodiment of the present disclosure. In an optional OCR step S1110, app2 can apply OCR or other scanning tools to recognize, from text displayed on the terminal emulator 100 (which executes at the cell phone or other hand-held or wearable operator display device), preprogrammed fields that may require operator response. An intercept detection step S1120 executes when the displayed fields change or are refreshed, to determine if the terminal emulator fields require an operator response. If no response is indicated, action can pass to field extraction step S240 and display rendering step 250 if applicable, as previously described. If response is indicated, a task determination step S1130 uses pre-programmed operator setup information and intercept rules (as described subsequently) to determine what type of surrogate response from an operator input device is acceptable.

Step S1130 also sets a trigger event for operator response, based on the pre-programmed operator setup. For example, operator setup may indicate that a second scanner actuation entry suffices as the surrogate operator response or trigger to a prompt that requests quantity or to a prompt requiring confirmation, such as task completion. Merely pressing the scanner activation button, whether or not a proper bar code (or other code) is obtained, and regardless of any code obtained, would then suffice for an operator trigger response action. A monitoring step S1140 reports an operator action as a candidate trigger event. A trigger detection step S1150 determines if the reported operator action is a valid trigger event; otherwise, a false trigger step S1160 restores monitoring activity. If a valid trigger event is detected in step S1150, a task response step S1170 then substitutes the predetermined modified data or signal for the original trigger data, passing this modified data to the host processor so that the cycle of FIG. 11 completes for the given task and subsequent tasks can be undertaken. For example, where a scanner is used as the trigger device, Step S1170 sends the replacement signal to the host system 12 instead of sending scanned barcode data acquired by the scanner. Step S1170 can then “reset” the trigger, so that subsequent barcode scans are not considered to be trigger events, or to have any other meaning than conventional scanned data signals, until the next intercept is detected at step S1120.

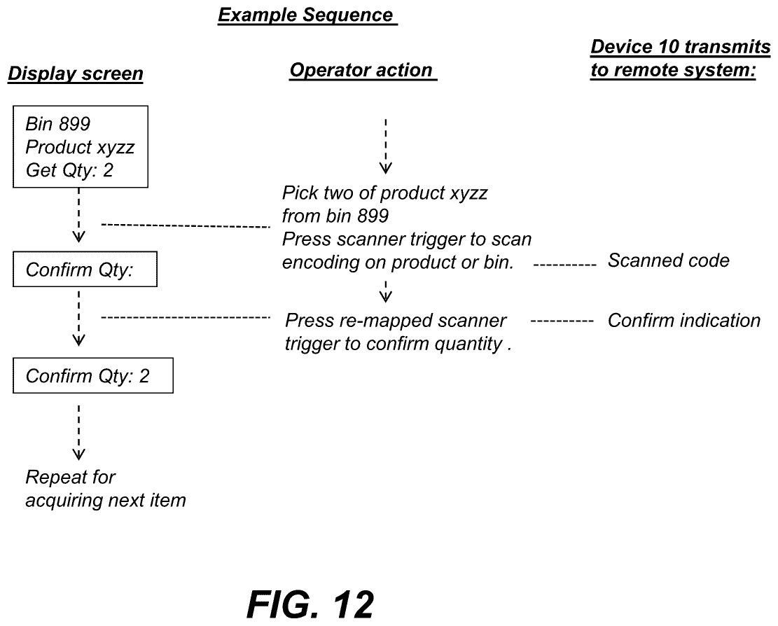

The sequence chart in FIG. 12 gives one exemplary sequence in which the same operator entry (pressing the scanner trigger) is first interpreted to provide encoded, scanned data and is subsequently interpreted to provide a confirmation as a “binary” (yes/no) type of prompt response. In this example, the screen sequence first provides the operator instruction to obtain two items from a bin location. The operator, pressing the scan button, scans the item encoding, which is transmitted back to the remote system by display device 10. The encoding can be a bar code, QR code, or other encoding, for example. Next, the display screen prompts the operator to confirm completion of the task with a binary (yes/no) response. The confirm indication that is sent back to the host system from device 10 can be a single text character (e.g. “Y”) or other binary type of signal. Following transmission of the re-mapped response signal, the scanner re-mapping can be reset, so that subsequent scans are interpreted as conventional scanner data.

Different input behavior can be used for different replies, so that confirmation of a product quantity can be made by repeating a valid scan; failure of the scanner to obtain valid data can indicate a negative response. The same cycle can repeat for additional items. As this sequence shows, pressing the scanner trigger can have different significance, and generate different response data depending on the context of the operator action. It can be appreciated that a third actuation of the scanner trigger could further be used to advance the sequence for displaying the next product, for example, causing device 10 to send a third type of message to the remote system (e.g. “Next”).

It should also be noted that the re-mapped or reinterpreted signal from the scanner relates to scanner activation and not to any particular encoded data provided for this actuation. For example, the scanner need not be aimed at an encoding label in order to provide the re-mapped response. An operator can simply aim the scanner at the floor or ceiling and press the trigger or “scan” control for this second, re-mapped actuation. Thus, even an “undecipherable code” reading from the scanner can be sufficient to enable the re-mapped response to be substituted and submitted for transmission back to host server 12.

### User Setup for Prompt/Response Management

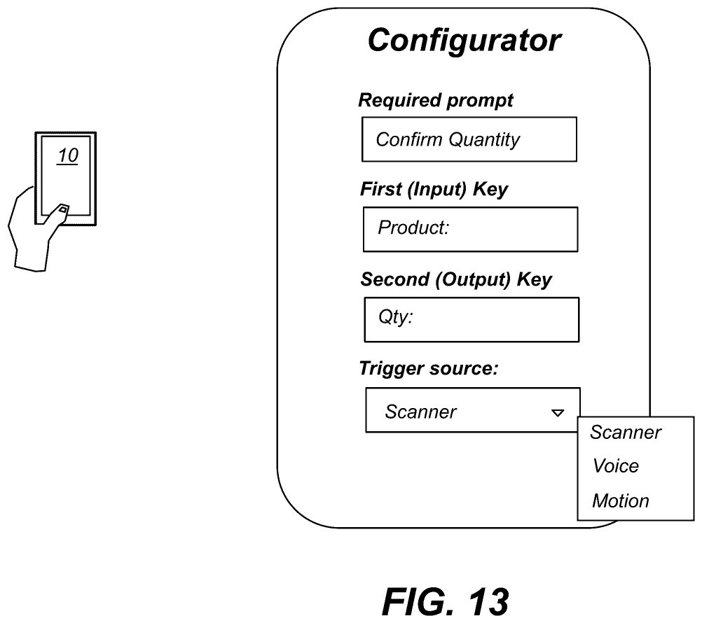

Referring back to the FIG. 10B schematic, the configuration of the App2 120 application allows the user to designate the particular fields/terms that prompt operator response and to indicate what operator actions can serve as the “surrogate” response triggers described with reference to FIG. 10B. FIG. 13 shows an exemplary interface for this setup, along with user-specified fields for response. Among setup fields and parameters, the following can be configured:
Prompt or header text for the displayed content;
Labels and keywords for text fields;
One or more text strings indicating instructions for operator reply;
Trigger entry device (for example, scanner, ring scanner, IMU, screen tap, microphone for audio confirmation, motion or position detector, or other user input device);
Other instructions for system interpretation of the trigger entry device and data substitution;
and
Visual treatment for a field that currently requires a response, such as highlighting, use of color, etc.

It can be appreciated that there can be numerous possible arrangements for assigning a remapped response to a displayed prompt, using any of a number of different user devices as input. While a straightforward sequence can be setup, such as actuating the scanner a first time for scanning a label, then a second time for verifying a default quantity, the intermediary app2 can be configured to remap any suitable input device for prompt response, without requiring multiple uses of the same device for different purposes.

The invention has been described in detail, and may have been described with particular reference to a suitable or presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method comprising:
displaying information content received from a remote host system on a display that is controlled from a first processor that is separate from the remote host system;
identifying, in the displayed information content, at least one predetermined prompt field that prompts an operator response to the remote host system;
receiving an event signal that corresponds to the operator response from an input device that is in signal communication with the first processor;
in response to the prompt field identification and to the received event signal, actuating a pre-determined remapping that re-interprets the event signal received from the operator at the first processor as a remapped signal that is the response to the predetermined prompt field;
transmitting the remapped signal from the first processor to the remote host system as the operator response to the predetermined prompt field;
and
re-setting the remapping of the event signal.

2. The method of claim 1 wherein the display is a first display and further comprising rendering the at least one prompt on a second display that is in signal communication with the first processor.

3. The method of claim 1 wherein identifying the at least one predetermined prompt field comprises using optical character recognition on pixelated display content.

4. The method of claim 1 wherein the input device is a scanner.

5. The method of claim 1 wherein the input device senses an audio signal.

6. The method of claim 1 wherein the input device is a position sensor.

7. The method of claim 3 wherein the display is on a wearable display device that is in wireless signal communication with the first processor.

8. The method of claim 1 further comprising refreshing the display screen in response to the remapped signal.

9. The method of claim 1 wherein the display screen is not energized.

10. The method of claim 1 further comprising identifying a first alphanumeric text string in the displayed information content and using it in the process of remapping a second alphanumeric text string obtained from the event signal.

11. A method comprising:
(a) acquiring a screen capture, as a pixelated image, from a display, wherein the pixelated image is generated according to instructions from a remote host system that is in wireless communication with a processor driving display;
(b) processing the acquired pixelated image to identify at least one textual prompt for operator response;
(c) re-interpreting a scan signal acquired by the operator as a textual response to the at least one textual prompt; and
(d) transmitting, to the remote host system, a signal indicative of the re-interpreted response, wherein the re-interpreted response confirms information in the processed pixelated image.

12. The method of claim 11 wherein processing the pixelated image comprises applying optical character recognition.

13. A method comprising:
displaying information content received from a remote host system on a display that is controlled from a first processor that is separate from the remote host system;
identifying, in the displayed information content, at least one predetermined prompt field that prompts an operator response;
receiving a first event signal that corresponds to the operator response from an input device that is external to, and in signal communication with, the first processor and transmitting the first event signal from the first processor to the remote host system;
in response to the prompt field identification and to the received first event signal, actuating a pre-determined remapping that re-interprets a second event signal received from the operator at the first processor as a remapped signal that is a response to the predetermined prompt field;
transmitting the remapped signal from the first processor to the remote host system as the response to the predetermined prompt field;
and
re-setting the remapping of the event signal.

14. The method of claim 13 wherein the first and second event signals are from the same input device.

15. The method of claim 14 wherein the input device is a handheld scanner.

16. The method of claim 13 wherein the pre-determined remapping is programmed using the display controlled from the first processor.

17. The method of claim 13 wherein the input device is a position sensor.

18. The method of claim 13 wherein the display is a wearable display device that is in wireless signal communication with the first processor.
